(19) United States
(12) Patent Application Publication
(10) Pub. No.: US 2024/0289227 A1
(43) Pub. Date: Aug. 29, 2024

(54) VIRTUALIZED SYSTEM FAULT ISOLATION DEVICE AND VIRTUALIZED SYSTEM FAULT ISOLATION METHOD

(71) Applicant: Nippon Telegraph and Telephone Corporation, Tokyo (JP)

(72) Inventors: Masaki UENO, Musashino-shi, Tokyo (JP); Noritaka HORIKOME, Musashino-shi, Tokyo (JP); Kenta SHINOHARA, Musashino-shi, Tokyo (JP)

(21) Appl. No.: 18/571,435

(22) PCT Filed: Jun. 29, 2021
(86) PCT No.: PCT/JP2021/024527

§ 371 Date: Dec. 18, 2023

(51) Int. Cl. G06F 11/14; G06F 11/07

(52) U.S. Cl. CPC G06F 11/1423; G06F 11/0712; G06F 11/1443

(57) ABSTRACT

A calculation resource cluster that is virtually created on a physical machine by container virtualization software and in which containers virtually created on the physical machine by the container virtualization software are clustered and arranged; and a cluster management unit that is virtually created and manages control related to arrangement and operation of the containers clustered. Further, included are: an abnormality detection unit that is created at an outside of components virtually created and detects an abnormality in the containers; and an abnormality recovery handling unit that is created at the outside and transmits a change command to the cluster management unit at the time of detection by the abnormality detection unit. The cluster management unit sets a distribution ratio of an end point setting unit associated with an abnormal container to 0% in response to the change command.

### TECHNICAL FIELD

The present invention relates to a virtualization system failure separation device and a virtualization system failure separation method that implement abnormality detection and failure recovery for a container or an application operating on the container in a virtual machine or a computing base based on the container.

### BACKGROUND ART

The virtual machine described above is a computer that implements the same functions as those of a physical computer by software. The container is a virtualization technology that is created by packaging an application in an environment called a “container” and operates on a container engine. In a conventional container-based technology, abnormality detection and failure recovery for a container or an application operating on the container are implemented mainly by a Liveness/Readiness Probe function (also referred to as a probe function) to be described later of Kubernetes to be described later.

Kubernetes is container virtualization software that creates and clusters containers, such as Docker, and is open source software. The Liveness Probe function performs control such as restarting the container, and the Readiness Probe function performs control such as of whether or not the container receives a request. As this type of conventional technology, there is a technology described in Non Patent Literature 1.

### CITATION LIST

### Non Patent Literature

Non Patent Literature 1: “Configure Liveness, Readiness and Startup Probes,” kubernetes, [online], [searched on Jun. 10, 2021], Internet <https://kubernetes.io/ja/docs/tasks/configure-pod-container/configure-liveness-readiness-startup-probes/>

### SUMMARY OF INVENTION

### Technical Problem

Meanwhile, not limited to the container described above, in a virtualization system as a virtualization technology area, recovery work or the like by human power is performed on a failure in the virtualization system on the basis of an alert issued. However, since the recovery work is performed by human power after the alert is issued, it is difficult to shorten the time from occurrence of the failure to normalization.

In a case where the failure is recovered by the probe function of Kubernetes, which performs failure recovery, a failure monitoring cycle can be set only to a predetermined slow cycle such as one second. For this reason, there has been a problem that, in a case where the failure recovery as soon as possible is required, the failure cannot be recovered earlier than the recovery by the failure recovery function of Kubernetes in a default state.

The present invention has been made in view of such circumstances, and an object thereof is to recover from a failure occurring in a virtualization system earlier than recovery by a failure recovery function of container virtualization software.

### Solution to Problem

To solve the above problems, a virtualization system failure separation device of the present invention includes: a calculation resource cluster that is virtually created on a physical machine by container virtualization software and in which containers virtually created on the physical machine by the container virtualization software are clustered and arranged; a cluster management unit that is virtually created on the physical machine by the container virtualization software and manages control related to arrangement and operation of the containers clustered; a deployment instruction unit that performs processing of arranging an end point setting unit that is associated with a plurality of containers and serves as an end point of communication data in which a distribution ratio of traffic to each container is set, in association with the containers; an abnormality detection unit that is created at an outside of the calculation resource cluster and the cluster management unit that are virtually created and detects an abnormality in the containers; and an abnormality recovery handling unit that is created at the outside and transmits, to the cluster management unit, a change command for setting the distribution ratio to an abnormal container detected by the abnormality detection unit to 0%, in which the cluster management unit sets the distribution ratio of the end point setting unit associated with the abnormal container to 0% in response to the change command.

### Advantageous Effects of Invention

According to the present invention, it is possible to recover from a failure occurring in a virtualization system earlier than recovery by a failure recovery function of container virtualization software.

### BRIEF DESCRIPTION OF DRAWINGS

FIG. 1 is a block diagram illustrating a configuration of a virtualization system failure separation device according to an embodiment of the present invention.

FIG. 2 is a block diagram for explaining first abnormality detection processing for containers by Pods of the virtualization system failure separation device of the present embodiment.

FIG. 3 is a block diagram for explaining second abnormality detection processing using a routing table provided for each of worker nodes of the virtualization system failure separation device of the present embodiment.

FIG. 4 is a block diagram for explaining third abnormality detection processing by monitoring a daemon of a virtual switch provided for each worker node of the virtualization system failure separation device of the present embodiment.

FIG. 5 is a block diagram for explaining fourth abnormality detection processing by monitoring a daemon of a container runtime provided for each worker node of the virtualization system failure separation device of the present embodiment.

FIG. 6 is a block diagram for explaining fifth abnormality detection processing by monitoring each worker node of the virtualization system failure separation device of the present embodiment.

FIG. 7 is a block diagram for explaining sixth abnormality detection processing by monitoring DBs externally attached to a cluster of a container system of the virtualization system failure separation device of the present embodiment.

FIG. 8 is a block diagram illustrating a configuration when an end point setting unit and a Pod by a failure handling deployment instruction unit are deployed as a 1:1 configuration in the virtualization system failure separation device of the present embodiment.

FIG. 9 is a block diagram for explaining first abnormality handling processing performed by the virtualization system failure separation device of the present embodiment.

FIG. 10 is a flowchart for explaining operation of the first abnormality handling processing.

FIG. 11 is a block diagram for explaining second abnormality handling processing performed by the virtualization system failure separation device of the present embodiment.

FIG. 12 is a hardware configuration diagram illustrating an example of a computer that implements functions of the virtualization system failure separation device according to the present embodiment.

### DESCRIPTION OF EMBODIMENTS

Hereinafter, embodiments of the present invention will be described with reference to the drawings. However, in all the drawings in this specification, components having corresponding functions are denoted by the same reference numerals, and explanation of them will not be repeated as appropriate.

### <Configuration of Embodiment>

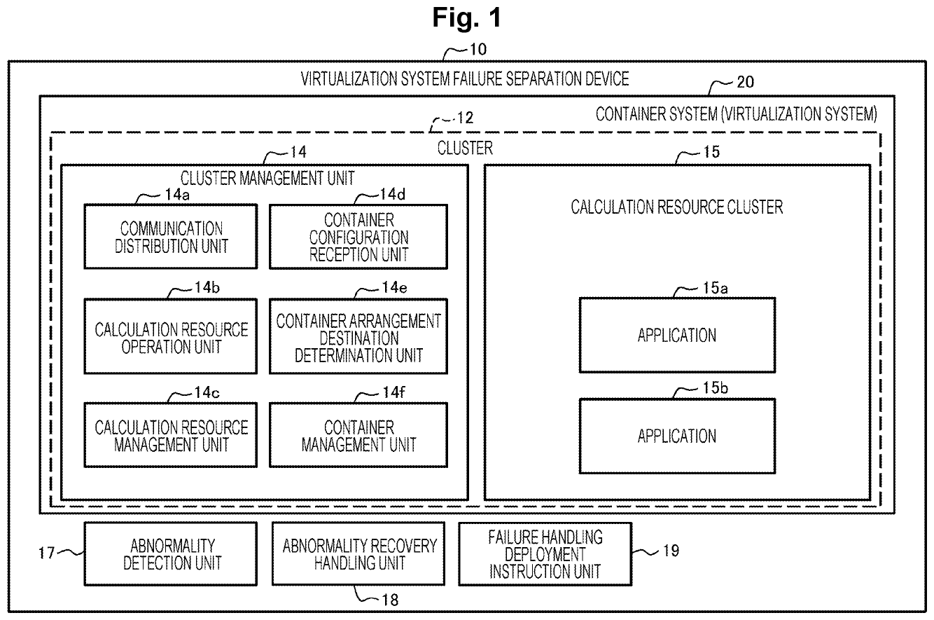

FIG. 1 is a block diagram illustrating a configuration of a virtualization system failure separation device according to an embodiment of the present invention.

A virtualization system failure separation device (also referred to as a failure separation device) 10 illustrated in FIG. 1 stops or deletes and separates a container in which a failure in a container system 20 described later has occurred, and recovers the container after separation. The failure separation device 10 includes a cluster management unit 14, a calculation resource cluster 15, an abnormality detection unit 17, an abnormality recovery handling unit 18, and a failure handling deployment instruction unit 19. The cluster management unit 14 and the calculation resource cluster 15 constitute a cluster 12. The abnormality detection unit 17, the abnormality recovery handling unit 18, and the failure handling deployment instruction unit 19 are provided outside the cluster 12. Note that the failure handling deployment instruction unit 19 constitutes a deployment instruction unit described in the claims.

The calculation resource cluster 15 includes a plurality of applications 15a and 15b. In other words, the applications 15a and 15b are Pods as units of management of an aggregate of one or a plurality of containers. The Pod is a minimum unit of an application that can be executed by Kubernetes (container virtualization software). That is, containers are created and clustered by the applications 15a and 15b as the Pods, and this cluster is operated on a container engine. The calculation resource cluster 15 is virtually created on a physical machine by container virtualization software, and containers virtually created on the physical machine by the container virtualization software are clustered and arranged therein.

The container system 20 is a virtualization system including one or a plurality of clusters 12. In a case where there are two clusters 12, each cluster 12 includes the cluster management unit 14 and the calculation resource cluster 15.

The cluster management unit 14 is virtually created on the physical machine by the container virtualization software, and manages control related to arrangement and operation of the containers clustered. The cluster management unit 14 includes a communication distribution unit 14a, a calculation resource operation unit 14b, a calculation resource management unit 14c, a container configuration reception unit 14d, a container arrangement destination determination unit 14e, and a container management unit 14f.

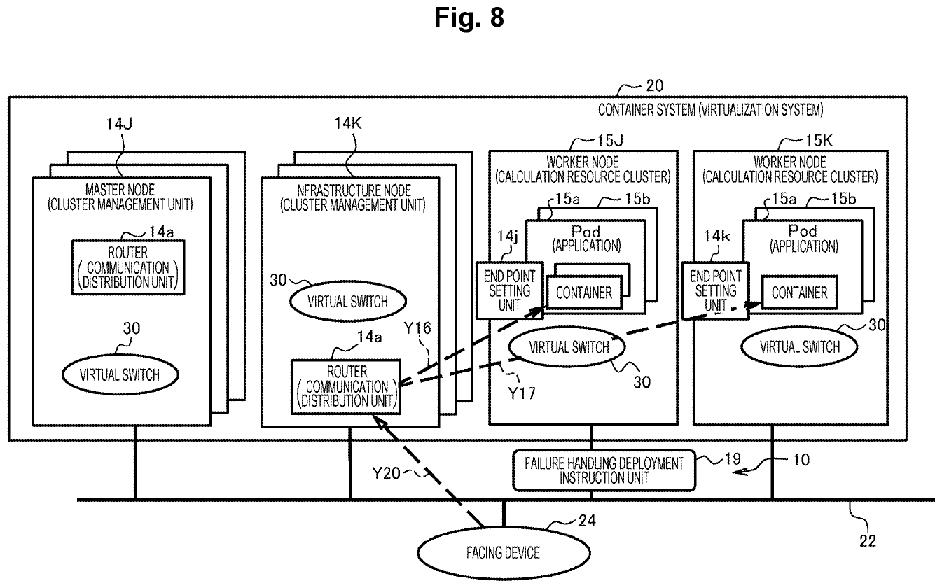

In the failure separation device 10 having such a configuration, the failure handling deployment instruction unit (also referred to as a deployment instruction unit) 19 performs processing of deploying (arranging) end point (end point) setting units 14j and 14k and Pods 15a and 15b illustrated in FIG. 8 as a 1:1 configuration. The end point setting units 14j and 14k each are associated with the plurality of Pods 15a and 15b, and a distribution ratio (%) of traffic to each of the Pods 15a and 15b is set, and serves as an end point of communication data. The distribution ratio is referred to as a weight value (%).

The abnormality detection unit 17 illustrated in FIG. 1 detects an abnormality in the Pods (applications) 15a and 15b that are one or a plurality of containers in the container system 20.

The abnormality recovery handling unit 18 changes the weight value of the deployment instruction unit 19 associated with the Pod (for example, the Pod 15a) in which the abnormality is detected by the abnormality detection unit 17 to 0%, and transmits a change command for separating the abnormal Pod 15a to the communication distribution unit 14a. In addition, when recovering the separated Pod 15a, the abnormality recovery handling unit 18 transmits, to the communication distribution unit 14a, a recovery command for gradually increasing the traffic to the Pod 15a to be recovered to a predetermined traffic value.

The communication distribution unit 14a illustrated in FIG. 1 is a router, and performs distribution and notification of the change command or the recovery command from the abnormality recovery handling unit 18 to the corresponding units 14b to 14f. In addition, on the basis of the weight value (%) indicating a traffic distribution ratio set for each of the end point setting units 14j and 14k described later, the communication distribution unit 14a distributes the traffic to the end point setting units 14j and 14k (described later) of transmission destinations. Note that the weight value corresponds to the distribution ratio described in the claims.

The container configuration reception unit (also referred to as a reception unit) 14d receives configuration information for deploying a container to the calculation resource cluster 15 from an external server or the like.

The container arrangement destination determination unit (also referred to as an arrangement destination determination unit) 14e determines which container is arranged in which worker node (calculation resource cluster 15) on the basis of the configuration information received by the reception unit 14d.

The container management unit 14f checks whether or not the container is normally operating.

The calculation resource management unit 14c grasps and manages whether or not a worker node is operable, a use amount of a calculation resource of a server constituting the worker node, a remaining amount of a central processing unit (CPU), and the like.

The calculation resource operation unit 14b performs an operation of allocating a predetermined amount of calculation resources such as a certain amount of CPU to a certain container, in other words, an operation of allocating a storage capacity, a CPU time, a memory capacity available to the container, and the like.

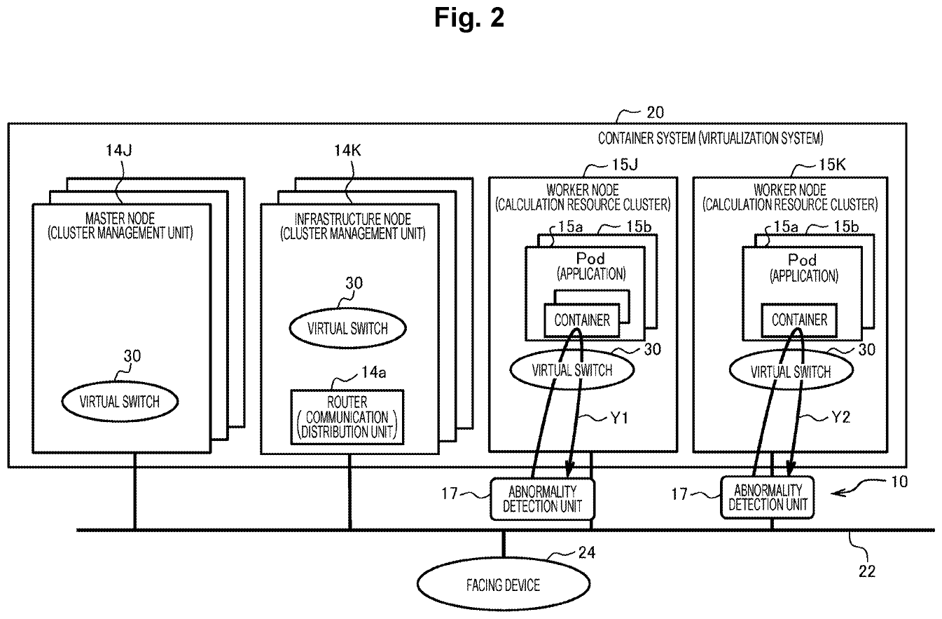

Next, various types of abnormality detection processing (first to sixth abnormality detection processing) related to the container of the container system 20 by the abnormality detection unit 17 of the failure separation device 10 will be described with reference to FIGS. 2 to 7.

### <First Abnormality Detection Processing>

FIG. 2 is a block diagram for explaining first abnormality detection processing for containers by the Pods (applications) 15a and 15b of the virtualization system failure separation device 10 of the present embodiment. However, the Pods 15a and 15b constitute one or a plurality of containers.

In FIG. 2, in the container system 20, a master node 14J, an infrastructure node 14K, and worker nodes 15J and 15K are configured by a virtual machine, and are connected to each other by respective virtual switches {Open vSwitches (OVSs)} 30. The master node 14J and the infrastructure node 14K correspond to the cluster management unit 14 (FIG. 1), and the worker nodes 15J and 15K correspond to the calculation resource cluster 15 (FIG. 1).

Further, the master node 14J and the worker node 15J constitute a first cluster 12, and the infrastructure node 14K and the worker node 15K constitute a second cluster 12. It is assumed that the container system 20 includes these clusters 12.

The abnormality detection unit 17 is arranged outside the container system 20 similarly to the configuration of FIG. 1. In FIG. 2, a total of two abnormality detection units 17 are illustrated for the respective worker nodes 15J and 15K, but the number of abnormality detection units 17 may be one. The master node 14J, the infrastructure node 14K, the worker nodes 15J and 15K, and the abnormality detection units 17 are connected to a facing device 24 via a network 22. The facing device 24 is a communication device such as an external server that transmits a request signal and the like to the container system 20.

The abnormality detection unit 17 transmits a predetermined command (for example, “sudo crictl ps”) to the Pods 15a and 15b of the worker nodes 15J and 15K by polling indicated by reciprocating arrows Y1 and Y2, and determines whether there is an abnormality or not depending on response results returned from the Pods 15a and 15b in response to the command. In this polling actual test, the average value of round-trip times when polling was executed 10 times was 0.06 seconds.

Abnormality determination in the abnormality detection unit 17 is performed by reading a character string indicating normal or abnormal described in the command response results returned from the Pods 15a and 15b by polling. For example, a character string “Running” indicates that operation of a container (Pod 15a, 15b) is normal, and a character string other than “Running” indicates that the operation is abnormal. For this reason, the abnormality detection unit 17 determines that the operation of the container (Pod 15a, 15b) is normal in a case where “Running” is described in the command response result, and determines that the operation is abnormal in a case where a character string other than “Running” is described.

### <Second Abnormality Detection Processing>

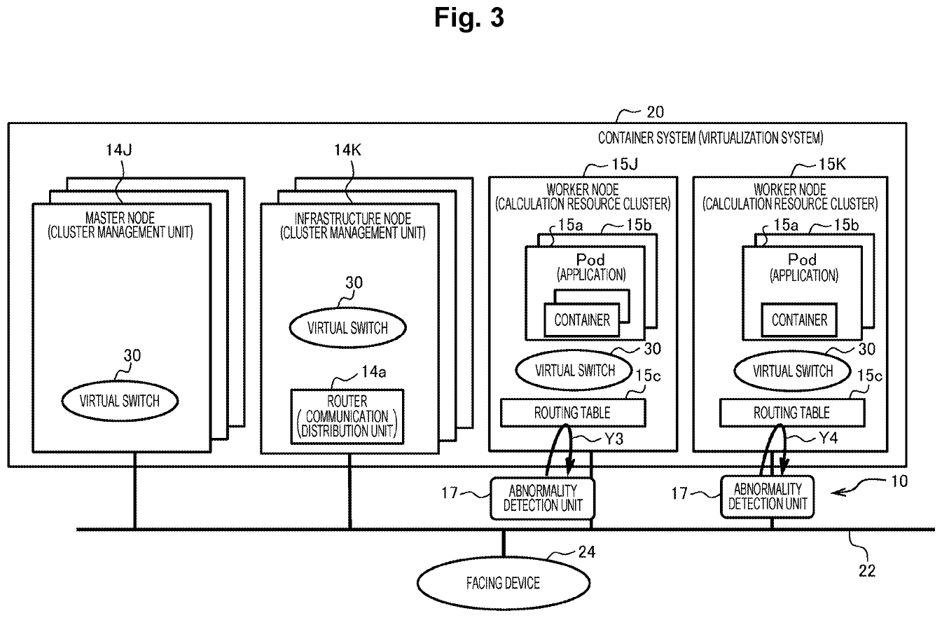

Next, FIG. 3 is a block diagram for explaining second abnormality detection processing using a routing table 15c provided for each of the worker nodes 15J and 15K of the virtualization system failure separation device 10 of the present embodiment.

The routing table (also referred to as a table) 15c manages containers of transmission destinations of packets transmitted from the facing device 24 to the Pods 15a and 15b of the worker nodes 15J and 15K via the network 22 with route information indicating the transmission destinations. If transmission destination management of the table 15c is incorrect, the packet does not reach an appropriate container. For this reason, the abnormality detection unit 17 detects whether the transmission destination management of the table 15c is normal or abnormal.

However, the routing table 15c includes a pair of tables “iptables” and “nftables”.

The abnormality detection unit 17 transmits a predetermined command to the tables 15c of the respective worker nodes 15J and 15K by polling indicated by reciprocating arrows Y3 and Y4, and determines whether there is an abnormality or not depending on response results returned from the tables 15c in response to the command.

The predetermined command is a pair of “sudo iptables-L|wc-|” and “sudo nft list ruleset”. Notification of the command “sudo iptables-L|wc-|” is performed to “iptables” of the table 15c, and notification of the command “sudo nft list ruleset” is performed to “nftables”. Then, each table of “iptables” and “nftables” returns a response depending on the command to the abnormality detection unit 17.

In the polling actual test by a pair of commands, the average value of round-trip times when polling was executed 10 times was 0.03 seconds in a case of the command “sudo iptables-L|wc-|” and 0.08 seconds in a case of the command “sudo nft list ruleset”.

In the abnormality determination in the abnormality detection unit 17, it is determined that there is no abnormality if the route information of the transmission destination is described in the command response result returned from each table 15c, and it is determined that there is an abnormality if nothing is described.

### <Third Abnormality Detection Processing>

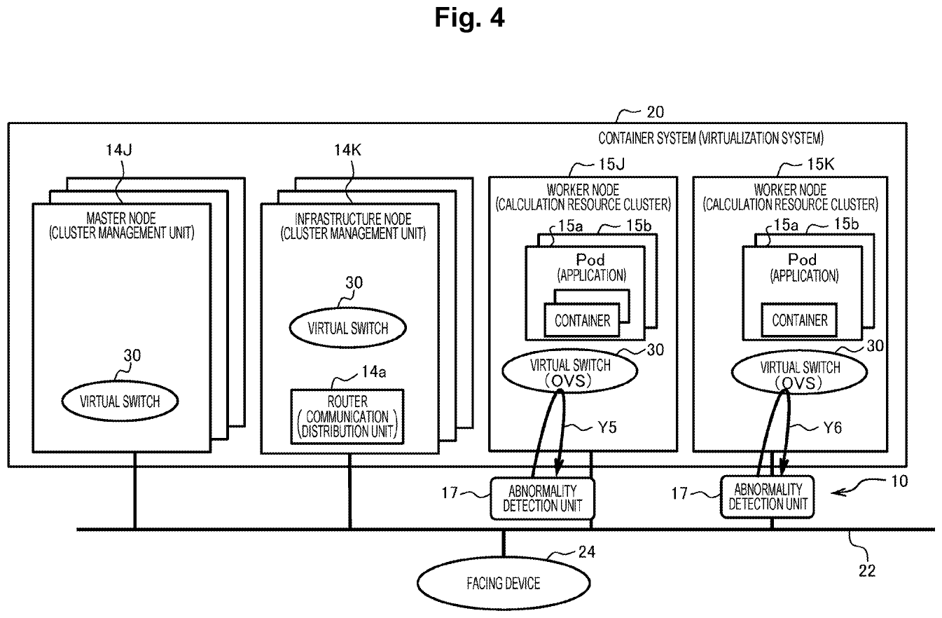

Next, FIG. 4 is a block diagram for explaining third abnormality detection processing by monitoring a daemon of a virtual switch 30 provided for each of the worker nodes 15J and 15K of the virtualization system failure separation device 10 of the present embodiment. The daemon of the virtual switch 30 is also referred to as an OVS daemon.

The daemon is a program for managing a transmission destination of a packet in the virtual switch 30. The abnormality detection unit 17 monitors the OVS daemon, and detects that there is no abnormality if the packet is properly transmitted, and detects that there is an abnormality if the packet is not properly transmitted.

The abnormality detection unit 17 transmits a predetermined command (for example, “ps aux|grep ovs-vswitchd|grep “db.sock”|wc-|”) to the virtual switches 30 for the respective worker nodes 15J and 15K by polling indicated by reciprocating arrows Y5 and Y6, and determines whether there is an abnormality or not depending on response results returned from the virtual switches 30 in response to the command.

In this polling actual test, the average value of the round-trip time when polling was executed 10 times was 0.03 seconds.

In the abnormality determination in the abnormality detection unit 17, it is determined that there is no abnormality if, for example, “db.sock process” related to the transmission destination is described in the command response result returned from each virtual switch 30, and it is determined that there is an abnormality if not described.

### <Fourth Abnormality Detection Processing>

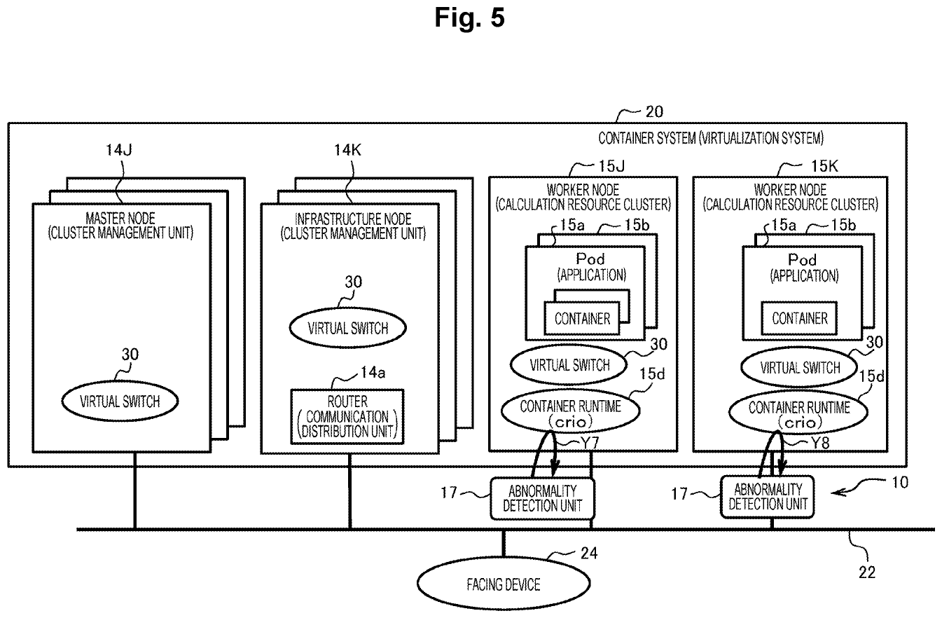

Next, FIG. 5 is a block diagram for explaining fourth abnormality detection processing by monitoring a daemon of a container runtime 15d provided for each of the worker nodes 15J and 15K of the virtualization system failure separation device 10 of the present embodiment. Note that the daemon of the container runtime 15d is also referred to as a crio daemon. Crio (cri-o) is an open source, community driven container engine used in container virtualization technology.

Since the container runtime 15d plays a role of activating the containers of the Pod 15a and 15b, it is possible to detect whether or not the containers are normally activated by monitoring the container runtime 15d. Thus, the abnormality detection unit 17 monitors the crio daemon, and detects that there is no abnormality if the container is activated, and detects that there is an abnormality if the container is not activated.

The abnormality detection unit 17 transmits a predetermined command (for example, “systemctl status crio|grep Active”) to the container runtimes 15d of the respective worker nodes 15J and 15K by polling indicated by reciprocating arrows Y7 and Y8, and determines whether there is an abnormality or not depending on response results returned from the container runtimes 15d in response to the command.

In this polling actual test, the average value of the round-trip time when polling was executed 10 times was 0.03 seconds.

In the abnormality determination in the abnormality detection unit 17, if “active (running)” indicating an activation state of the crio daemon is described in the command response result returned from each virtual switch 30, it is determined that there is no abnormality, and if the description is other than “active (running)”, it is determined that there is an abnormality.

### <Fifth Abnormality Detection Processing>

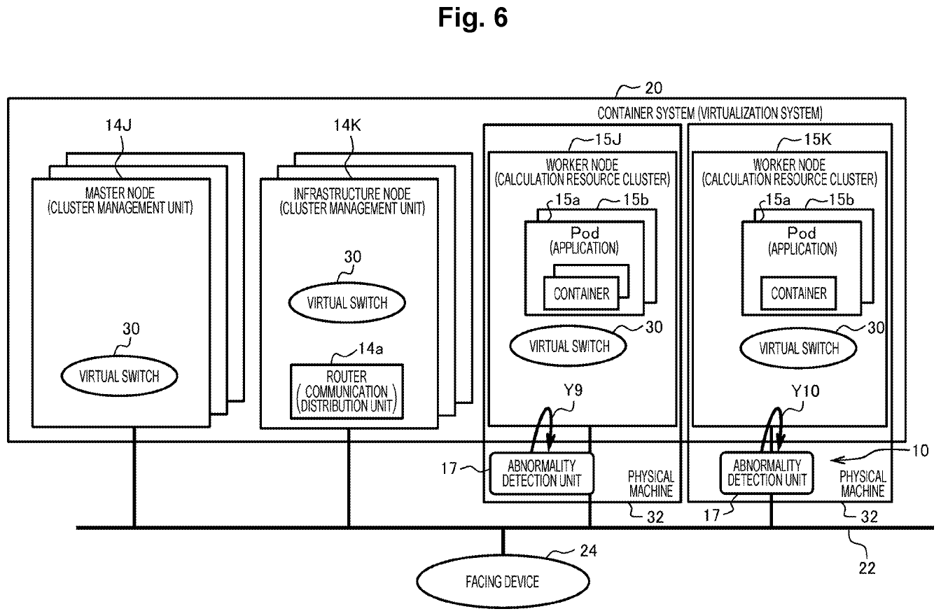

Next, FIG. 6 is a block diagram for explaining fifth abnormality detection processing by monitoring each of the worker nodes 15J and 15K of the virtualization system failure separation device 10 of the present embodiment.

However, a configuration is assumed in which the worker nodes 15J and 15K are created by a virtualization technology (virtual machine) using a physical machine 32. In this configuration, the abnormality detection unit 17 exists on the physical machine 32 outside the virtual machine, and the abnormality detection unit 17 detects that the container is normal if the virtual machine is activated, and detects that the container is abnormal if the virtual machine is not activated.

The abnormality detection unit 17 transmits a predetermined command (for example, “sudo virsh list”) to the worker nodes 15J and 15K by polling indicated by reciprocating arrows Y9 and Y10, and determines whether there is an abnormality or not depending on response results returned from the worker nodes 15J and 15K in response to the command.

In this polling actual test, the average value of the round-trip time when polling was executed 10 times was 0.03 seconds.

In the abnormality determination in the abnormality detection unit 17, it is determined that there is no abnormality if “Running” indicating an activation state of the target worker nodes 15J and 15K is described in the command response results returned from the worker nodes 15J and 15K, and it is determined that there is an abnormality if the description is other than “Running”.

### <Sixth Abnormality Detection Processing>

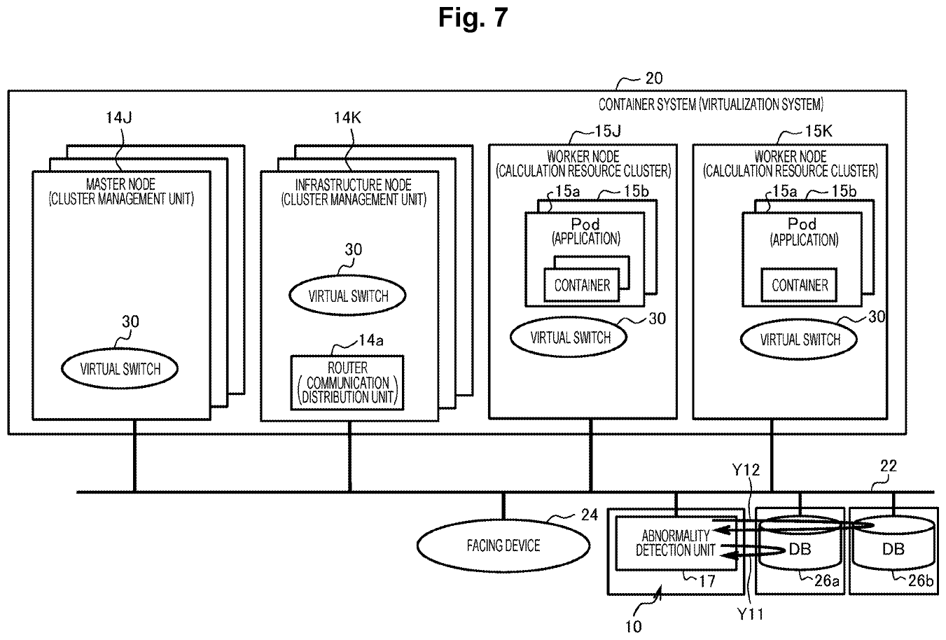

Next, FIG. 7 is a block diagram for explaining sixth abnormality detection processing by monitoring data bases (DBs) 26a and 26b externally attached to the cluster 12 of the container system 20 of the virtualization system failure separation device 10 of the present embodiment.

There is a configuration in which the DBs (also referred to as external DBs) 26a and 26b that store data related to the containers are connected, as external devices of the cluster 12 (FIG. 1), to worker nodes 15J and 15K via the network 22. At this time, the abnormality detection unit 17 is also connected to the worker nodes 15J and 15K via the network 22.

Here, since there is also a configuration in which a plurality of clusters 12 is connected to each other via the network 22, even if the abnormality detection unit 17 is connected to the cluster 12 via the network 22 as illustrated in FIG. 7, it is placed as the abnormality detection unit 17 in the failure separation device 10 as illustrated in FIG. 1.

The abnormality detection unit 17 transmits a predetermined command to the external DBs 26a and 26b via the network 22 by polling indicated by reciprocating arrows Y11 and Y12, and determines whether there is an abnormality or not depending on response results returned from the external DBs 26a and 26b in response to the command. The command in this case depends on types of the external DBs 26a and 26b.

The response result includes a result related to response/activation monitoring and a result related to an excess of an upper limit of the number of connections. The response/activation monitoring monitors whether or not the external DBs 26a and 26b are normally activated. That is, the abnormality detection unit 17 determines that there is an abnormality if the response result describes contents that the external DBs 26a and 26b are not normally activated.

The excess of the upper limit of the number of connections indicates that the number of containers to which the external DBs 26a and 26b are connected exceeds a predetermined threshold value. That is, the abnormality detection unit 17 determines that there is an abnormality if the response result describes that the number of connected containers of the external DBs 26a and 26b exceeds the threshold value.

In this polling actual test, the polling round-trip time depends on the types of the external DBs 26a and 26b.

Next, a description will be given of abnormality handling processing at the time of first to sixth abnormality detection described above.

However, as illustrated in FIG. 8, it is assumed that the end point setting units 14j and 14k and the Pods 15a and 15b are deployed (arranged) as a 1:1 configuration by the failure handling deployment instruction unit 19.

The end point setting units 14j and 14k are end points to receive service information related to the communication indicated by an arrow Y20 from the facing device 24 via a router 14a, and are accessible by the Pod 15a and 15b. In other words, the service information from the facing device 24 is transmitted from the router 14a via the end point setting units 14j and 14k to the containers of the Pods 15a and 15b. In addition, the weight value (%) indicating the traffic distribution ratio is set for each of the end point setting units 14j and 14k.

The router 14a distributes the traffic to the end point setting units 14j and 14k of the transmission destinations as indicated by arrows Y16 and Y17 on the basis of the weight values. For example, it is assumed that the weight value of the end point setting unit 14j is set to 30% and the weight value of the end point setting unit 14k is set to 70%. In this case, 30% of data transmitted from the router 14a is distributed to the end point setting unit 14j in a direction indicated by the arrow Y16, and 70% is distributed to the end point setting unit 14k in a direction indicated by the arrow Y17.

### <First Abnormality Handling Processing>

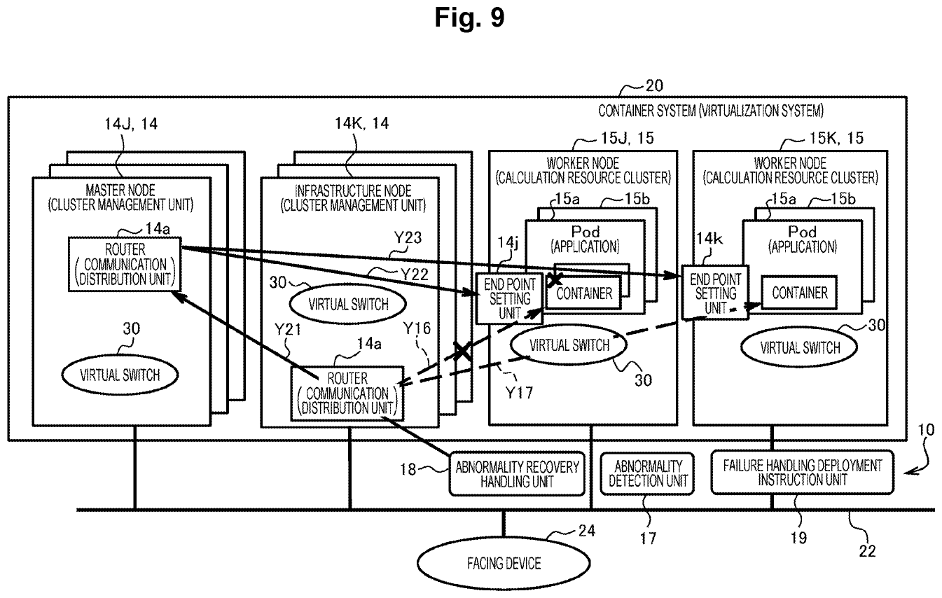

FIG. 9 is a block diagram for explaining first abnormality handling processing performed by the virtualization system failure separation device 10 of the present embodiment. The abnormality detection that requires the first abnormality handling processing is any one of the first to fifth abnormality detection.

When the abnormality detection unit 17 illustrated in FIG. 9 detects an abnormality in a Pod (for example, the Pod 15a of the worker node 15J), the abnormality recovery handling unit 18 transmits a change command for setting the traffic distribution ratio to the abnormal Pod 15a to 0% to the router 14a of the master node 14J as indicated by an arrow Y21.

The router 14a performs processing of separating the abnormal Pod 15a (see a cross mark) by setting the weight value of the end point setting unit 14j associated with the abnormal Pod 15a of the worker node 15J to 0% as indicated by an arrow Y22. At this time, the router 14a performs processing of setting the weight value of the end point setting unit 14k associated with the Pod 15a of the worker node 15K to 100% as indicated by an arrow Y23 as necessary.

Since the abnormal Pod 15a is separated by setting of the weight value, transmission data from the router 14a of the infrastructure node 14K is not transmitted in the direction indicated by the arrow Y16, and all (100%) of the transmission data is distributed and transmitted to the end point setting unit 14k in the direction indicated by the arrow Y17.

Next, processing in a case of recovering the abnormal Pod 15a of the separated worker node 15J will be described. In this case, the separated abnormal Pod 15a to be recovered is launched to a standby state after the abnormality is eliminated, by the master node 14J. Thereafter, the abnormality recovery handling unit 18 transmits, to the router 14a of the master node 14J, the recovery command for recovering the traffic to the launched Pod 15a by gradually increasing the traffic to the predetermined traffic value.

In response to the recovery command, the router 14a performs processing of gradually increasing the weight value of the end point setting unit 14j associated with the launched Pod 15a to the predetermined traffic value as indicated by the arrow Y22. By this processing, the weight value is set to a predetermined value (for example, 50%), and recovery of the Pod 15a is completed.

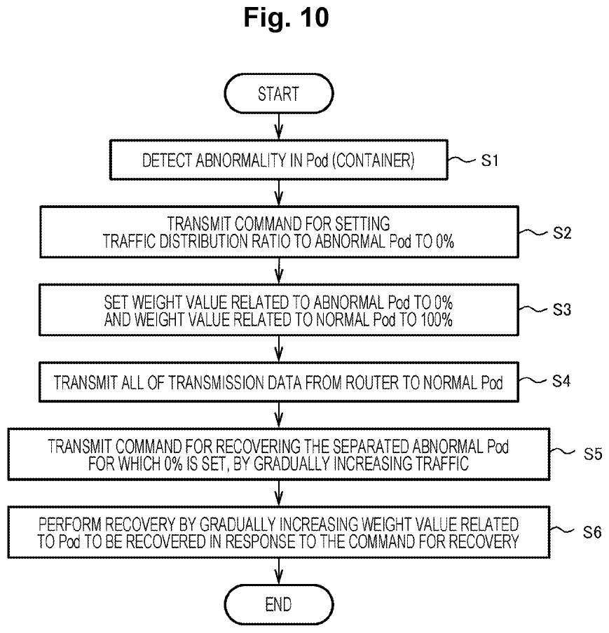

Next, operation of the first abnormality handling processing will be described with reference to FIG. 9 and a flowchart illustrated in FIG. 10.

However, the end point setting units 14j and 14k and the Pods (one or a plurality of containers) 15a and 15b are deployed as a 1:1 configuration by the failure handling deployment instruction unit 19. A precondition is set that a weight value (%) indicating a predetermined traffic distribution ratio is set to, for example, 50% for each of the end point setting units 14j and 14k.

In step S1 illustrated in FIG. 10, it is assumed that an abnormality in the Pod 15a (container) of the worker node 15J is detected by the abnormality detection unit 17 illustrated in FIG. 9.

At the time of detection of the abnormality, in step S2, as indicated by the arrow Y21, the abnormality recovery handling unit 18 transmits, to the router 14a of the master node 14J, the change command for setting the traffic distribution ratio to the abnormal Pod 15a to 0% (for example, “oc set route-backends Router name Pod name #1=100 Pod name #2=0*Pod name #1: Pod in which communication is continued, Pod name #2: Pod in which communication is inhibited”).

In step S3, the router 14a that has received the change command changes the weight value of the end point setting unit 14j associated with the abnormal Pod 15a of the worker node 15J from 50% to 0% as indicated by the arrow Y22. As a result, the abnormal Pod 15a is separated (see the cross mark). In addition, as indicated by the arrow Y23, the router 14a changes the weight value of the other end point setting unit 14k associated with the Pod 15a of the worker node 15K from 50% to 100%.

With this change, in step S4, all (100%) of the data transmitted from the router 14a of the infrastructure node 14K to the Pod 15a for each of the worker nodes 15J and 15K is transmitted to the normal Pod 15a via the end point setting unit 14k as indicated by the arrow Y17.

Thereafter, in a case where the separated abnormal Pod 15a is recovered, the abnormal Pod 15a separated by the master node 14J is launched to the standby state after the abnormality is eliminated. Thereafter, in step S5, the abnormality recovery handling unit 18 transmits, to the router 14a of the master node 14J, the recovery command for recovering the traffic to the launched Pod 15a by increasing the traffic to the predetermined traffic value gradually, for example, 10%, 30%, and 50%.

In step S6, in response to the recovery command, the router 14a recovers the Pod 15a to be recovered by increasing the weight value of the end point setting unit 14j associated with the Pod 15a to be recovered of the worker node 15J to the predetermined traffic value gradually to 10%, 30%, and 50% as indicated by the arrow Y22.

### <Second Abnormality Handling Processing>

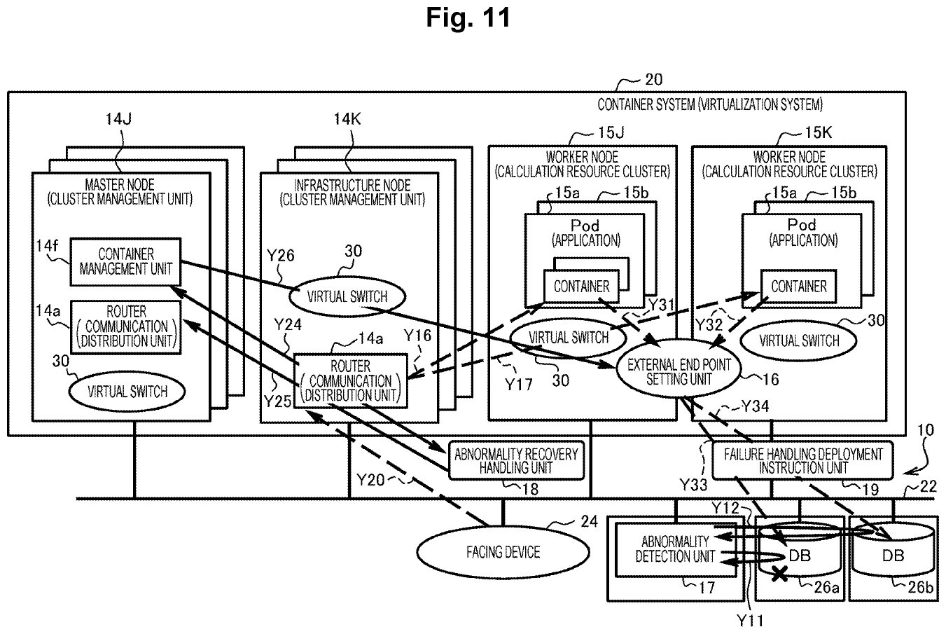

FIG. 11 is a block diagram for explaining second abnormality handling processing performed by the virtualization system failure separation device 10 of the present embodiment. The abnormality detection that requires the second abnormality handling processing is the sixth abnormality detection.

In a case where the second abnormality handling processing is performed, an external end point setting unit 16 is included associated to be shared by the Pods (15a and 15b) of the respective worker nodes 15J and 15K. In addition to this configuration, the external end point setting unit 16 is configured to be associated with the external DBs 26a and 26b of the end point (end point) destination by 1:n. These association configurations are performed by the deployment instruction unit 19.

The external end point setting unit 16 receives data indicated by an arrow Y31 or an arrow Y32 from the Pods 15a and 15b for each of the worker nodes 15J and 15K, and distributes and transmits the data to the plurality of external DBs 26a and 26b as indicated by arrows Y33 and Y34. In addition, in the external end point setting unit 16, a distribution ratio (%) for distributing the traffic at the time of transmission is set, and data is transmitted to the external DBs 26a and 26b by the traffic according to the distribution ratio.

In the above association configurations, in a case where an abnormality in the external DB (for example, the external DB 26a) is detected by the abnormality detection unit 17, the container management unit 14f deletes the end point of the abnormal external DB 26a from the external end point setting unit 16. With this deletion, communication of a Pod (for example, the Pod 15a of the worker node 15J) that performs communication to the deleted end point is inhibited.

In addition, in a case where the abnormality detection unit 17 detects an abnormality in the external DB 26a, the abnormality recovery handling unit 18 recognizes which external end point setting unit 16 has an Internet Protocol (IP) address of the detected external DB 26a. Note that the external DB 26a in which the abnormality is detected is referred to as an abnormal external DB 26a.

For this recognition, the abnormality recovery handling unit 18 makes an inquiry to the container management unit 14f as indicated by a bidirectional arrow Y24, and acquires, from the container management unit 14f, information of the external end point setting unit 16 that has the IP address of the abnormal external DB 26a.

The abnormality recovery handling unit 18 transmits a command for setting the acquired traffic distribution ratio to the external DB 26a of the IP address set in the external end point setting unit 16 to 0% to the router 14a of the master node 14J. The router 14a receives the command and notifies the container management unit 14f of the command.

The container management unit 14f changes the traffic distribution ratio to the abnormal external DB 26a set in the external end point setting unit 16 to 0%. As a result, the abnormal external DB 26a is separated (see a cross mark).

### <Hardware Configuration>

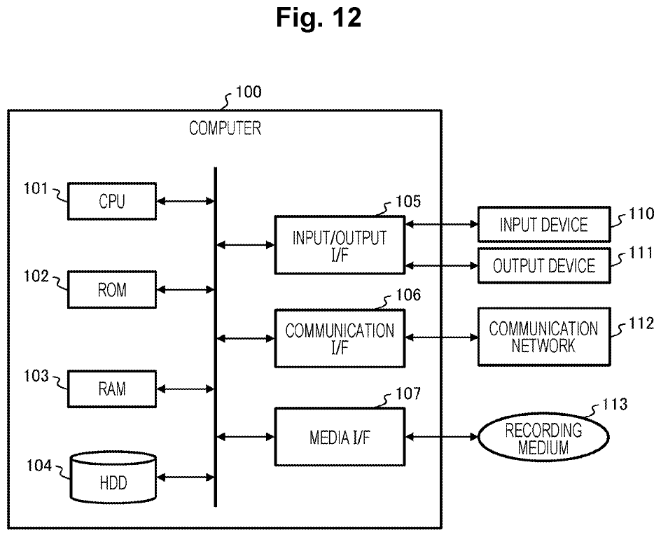

The virtualization system failure separation device 10 according to the embodiment described above is implemented by, for example, a computer 100 having a configuration as illustrated in FIG. 12. The computer 100 includes a central processing unit (CPU) 101, a read only memory (ROM) 102, a random access memory (RAM) 103, a hard disk drive (HDD) 104, an input/output interface (I/F) 105, a communication I/F 106, and a media I/F 107.

The CPU 101 operates on the basis of a program stored in the ROM 102 or the HDD 104, and controls each of functional units. The ROM 102 stores a boot program executed by the CPU 101 at the time of starting the computer 100, a program related to hardware of the computer 100, and the like.

The CPU 101 controls an output device 111 such as a printer and a display and an input device 110 such as a mouse and a keyboard via the input/output I/F 105. The CPU 101 acquires data from the input device 110 or outputs generated data to the output device 111 via the input/output I/F 105.

The HDD 104 stores a program executed by the CPU 101, data used by the program, and the like. The communication I/F 106 receives data from another device (not illustrated) via a communication network 112 and outputs the data to the CPU 101, and transmits the data generated by the CPU 101 to another device via the communication network 112.

The media I/F 107 reads a program or data stored in a recording medium 113, and outputs the program or data to the CPU 101 via the RAM 103. The CPU 101 loads a program related to target processing from the recording medium 113 on the RAM 103 via the media I/F 107, and executes the loaded program. The recording medium 113 is an optical recording medium such as a digital versatile disc (DVD) or a phase change rewritable disk (PD), a magneto-optical recording medium such as a magneto optical disk (MO), a magnetic recording medium, a conductor memory tape medium, a semiconductor memory, or the like.

For example, in a case where the computer 100 functions as the virtualization system failure separation device 10 according to the embodiment, the CPU 101 of the computer 100 implements functions of the virtualization system failure separation device 10 by executing the program loaded on the RAM 103. In addition, data in the RAM 103 is stored in the HDD 104. The CPU 101 reads a program related to target processing from the recording medium 113 and executes the program. In addition to this, the CPU 101 may read a program related to target processing from another device via the communication network 112.

### <Effects of Embodiment>

Effects of the virtualization system failure separation device 10 according to the embodiment of the present invention will be described.

(1a) The failure separation device 10 includes: the calculation resource cluster 15 that is virtually created on a physical machine by container virtualization software and clusters and arranges containers virtually created on the physical machine by the container virtualization software; and the cluster management unit 14 that is virtually created and manages control related to arrangement and operation of the clustered containers.

In addition, the failure separation device 10 includes: the deployment instruction unit 19 that performs processing of arranging the end point setting units 14j and 14k that each are associated with the plurality of containers and serve as end points of the communication data in which the distribution ratio of traffic to each container is set, in association with the containers; and the abnormality detection unit 17 that is created at the outside of the virtually created calculation resource cluster 15 and cluster management unit 14 and detects an abnormality in the containers.

Further, the failure separation device 10 includes the abnormality recovery handling unit 18 that is created outside and transmits a change command for setting the distribution ratio to the abnormal container detected by the abnormality detection unit 17 to 0% to the cluster management unit 14. The cluster management unit 14 is configured to set the distribution ratio of the end point setting unit (for example, the end point setting unit 14j) associated with the abnormal container to 0% in response to the change command.

According to this configuration, the traffic is 0 of communication of the abnormal container via the end point setting units 14j and 14k having the distribution ratio of 0%. For this reason, the abnormal container can be separated from the normal container. Since the abnormality detection unit 17 and the abnormality recovery handling unit 18 are not involved in the container virtualization software, recovery can be performed earlier than recovery by the failure recovery function for containers of the container virtualization software. Further explaining a reason why the recovery can be performed earlier, in the above-described failure recovery function, the failure monitoring cycle can be set only to a predetermined cycle, but in the present invention, regardless of the monitoring cycle, the failure in the container can be detected and the abnormal container can be stopped. For this reason, recovery can be performed earlier than recovery by the above-described failure recovery function.

(2a) At the time of recovery of the abnormal container, the abnormality recovery handling unit 18 transmits the recovery command for gradually increasing traffic to a container to be recovered to the predetermined traffic value to the cluster management unit 14. The cluster management unit 14 is configured to gradually increase the distribution ratio of the end point setting units 14j and 14k associated with the container to be recovered to the predetermined traffic value in response to the recovery command.

According to this configuration, when the abnormal container is recovered, the distribution ratio of the traffic of the end point setting units 14j and 14k associated with the abnormal container is gradually increased to the predetermined traffic value. For this reason, it is possible to reduce a risk that the traffic is rapidly increased at the time of container recovery and a failure occurs. In addition, since the recovery command is transmitted by the abnormality recovery handling unit 18 not involved in the container virtualization software to recover the abnormal container, recovery can be performed earlier than recovery by the failure recovery function for containers of the container virtualization software.

(3a) The failure separation device 10 includes: the calculation resource cluster 15 that is virtually created on a physical machine by container virtualization software and clusters and arranges containers virtually created on the physical machine by the container virtualization software; and the cluster management unit 14 that is virtually created and manages control related to arrangement and operation of the clustered containers.

In addition, the failure separation device 10 includes: the plurality of external DBs 26a and 26b that is connected to the outside of the calculation resource cluster 15 via a network and stores data related to the containers; and the external end point setting unit 16 that is associated with the plurality of containers of the calculation resource cluster 15 and associated with the plurality of external DBs 26a and 26b and in which the distribution ratio of the traffic when data from the containers is distributed and transmitted to the plurality of external DBs 26a and 26b is set.

In addition, the failure separation device 10 includes: the deployment instruction unit 19 that performs processing of arranging the end point setting units 14j and 14k that each are associated with the plurality of containers and serve as end points of the communication data in which the distribution ratio of traffic to each container is set, in association with the containers; and the abnormality detection unit 17 that is created at the outside of the virtually created calculation resource cluster 15 and cluster management unit 14 and detects an abnormality in the external DBs 26a and 26b. Further, the abnormality recovery handling unit 18 is included that is created at the outside and transmits, to the cluster management unit 14, the change command for setting the distribution ratio to the abnormality DB 26a detected by the abnormality detection unit 17 to 0%.

When an abnormality in an external DB (for example, the external DB 26a) is detected by the abnormality detection unit 17, the abnormality recovery handling unit 18 acquires information of the external end point setting unit 16 having the IP address of the detected abnormal external DB 26a from the cluster management unit 14, and transmits the command for setting the distribution ratio set in the external end point setting unit 16 of the acquired information to 0% to the cluster management unit 14. The cluster management unit 14 is configured to change the traffic distribution ratio to the abnormal external DB 26a to 0% in response to the command.

According to this configuration, the traffic is 0 of communication to the abnormal external DB 26a outside the calculation resource cluster 15 via the external end point setting unit 16 having the distribution ratio of 0%. For this reason, the abnormal external DBs 26a and 26b outside the calculation resource cluster 15 can be separated.

### <Effects>

(1) A virtualization system failure separation device is characterized by including: a calculation resource cluster that is virtually created on a physical machine by container virtualization software and in which containers virtually created on the physical machine by the container virtualization software are clustered and arranged; a cluster management unit that is virtually created on the physical machine by the container virtualization software and manages control related to arrangement and operation of the containers clustered; a deployment instruction unit that performs processing of arranging an end point setting unit that is associated with a plurality of containers and serves as an end point of communication data in which a distribution ratio of traffic to each container is set, in association with the containers; an abnormality detection unit that is created at an outside of the calculation resource cluster and the cluster management unit that are virtually created and detects an abnormality in the containers; and an abnormality recovery handling unit that is created at the outside and transmits, to the cluster management unit, a change command for setting the distribution ratio to an abnormal container detected by the abnormality detection unit to 0%, in which the cluster management unit sets the distribution ratio of the end point setting unit associated with the abnormal container to 0% in response to the change command.

According to this configuration, the traffic is 0 of communication of the abnormal container via the end point setting unit having the distribution ratio of 0%. For this reason, the abnormal container can be separated from the normal container. Since the abnormality detection unit and the abnormality recovery handling unit are not involved in the container virtualization software, recovery can be performed earlier than recovery by the failure recovery function for containers of the container virtualization software. Further explaining a reason why the recovery can be performed earlier, in the above-described failure recovery function, the failure monitoring cycle can be set only to a predetermined cycle, but in the present invention, regardless of the monitoring cycle, the failure in the container can be detected and the abnormal container can be stopped. For this reason, recovery can be performed earlier than recovery by the above-described failure recovery function.

(2) The virtualization system failure separation device according to (1) is characterized in that the abnormality recovery handling unit transmits a recovery command for gradually increasing traffic to a container to be recovered to a predetermined traffic value to the cluster management unit at a time of recovery of the abnormal container, and the cluster management unit gradually increases the distribution ratio of the end point setting unit associated with the container to be recovered to the predetermined traffic value in response to the recovery command.

According to this configuration, when the abnormal container is recovered, the distribution ratio of the traffic of the end point setting unit associated with the abnormal container is gradually increased to the predetermined traffic value. For this reason, it is possible to reduce a risk that the traffic is rapidly increased at the time of container recovery and a failure occurs. In addition, since the recovery command is transmitted by the abnormality recovery handling unit not involved in the container virtualization software to recover the abnormal container, recovery can be performed earlier than recovery by the failure recovery function for containers of the container virtualization software.

(3) A virtualization system failure separation device is characterized by including: a calculation resource cluster that is virtually created on a physical machine by container virtualization software and in which containers virtually created on the physical machine by the container virtualization software are clustered and arranged; a cluster management unit that is virtually created on the physical machine by the container virtualization software and manages control related to arrangement and operation of the containers clustered; a plurality of data bases (DBs) that is connected outside the calculation resource cluster via a network and stores data related to the containers; an external end point setting unit that is associated with the plurality of containers of the calculation resource cluster and associated with the plurality of DBs and in which a distribution ratio of traffic when data from the containers is distributed and transmitted to the plurality of DBs is set; an abnormality detection unit that is created at an outside of the calculation resource cluster and the cluster management unit that are virtually created and detects an abnormality in the DBs; and an abnormality recovery handling unit that is created at the outside and transmits, to the cluster management unit, a change command for setting the distribution ratio to an abnormal DB detected by the abnormality detection unit to 0%, in which when the abnormality in the DBs is detected by the abnormality detection unit, the abnormality recovery handling unit acquires information of the external end point setting unit having an Internet Protocol (IP) address of the abnormality DB detected, from the cluster management unit, and transmits a command for setting the distribution ratio set in the external end point setting unit of the information acquired to 0% to the cluster management unit, and the cluster management unit changes the distribution ratio of the traffic to the abnormal DB to 0% in response to the command.

According to this configuration, the traffic is 0 of communication to the abnormal DB outside the calculation resource cluster via the external end point setting unit having the distribution ratio of 0%. For this reason, the abnormal DB outside the calculation resource cluster can be separated.

In addition to the above, the specific configuration can be modified as appropriate, without departing from the scope of the present invention.

### REFERENCE SIGNS LIST

10 virtualization system failure separation device
14 cluster management unit
14a communication distribution unit
14b calculation resource operation unit
14c calculation resource management unit
14d container configuration reception unit
14e container arrangement destination determination unit
14f container management unit
14j, 14k end point setting unit
15 calculation resource cluster
15a, 15b application
16 external end point setting unit
17 abnormality detection unit
18 abnormality recovery handling unit
19 failure handling deployment instruction unit (deployment instruction unit)
26a, 26b external DB (DB)

1. A virtualization system failure separation device comprising:
a calculation resource cluster that is virtually created on a physical machine by container virtualization software and in which containers virtually created on the physical machine by the container virtualization software are clustered and arranged;
a cluster management unit that is virtually created on the physical machine by the container virtualization software and configured to manage control related to arrangement and operation of the containers clustered;
a deployment instruction unit configured to perform processing of arranging an end point setting unit that is associated with a plurality of containers and serve as an end point of communication data in which a distribution ratio of traffic to each container is set, in association with the containers;
an abnormality detection unit that is created at an outside of the calculation resource cluster and the cluster management unit that are virtually created and configured to detect an abnormality in the containers; and
an abnormality recovery handling unit that is created at the outside and configured to transmit, to the cluster management unit, a change command for setting the distribution ratio to an abnormal container detected by the abnormality detection unit to 0%, wherein
the cluster management unit configured to set the distribution ratio of the end point setting unit associated with the abnormal container to 0% in response to the change command.

2. The virtualization system failure separation device according to claim 1, wherein
the abnormality recovery handling unit is configured to transmit a recovery command for gradually increasing traffic to a container to be recovered to a predetermined traffic value to the cluster management unit at a time of recovery of the abnormal container, and
the cluster management unit is configured to gradually increase the distribution ratio of the end point setting unit associated with the container to be recovered to the predetermined traffic value in response to the recovery command.

3. A virtualization system failure separation device comprising:
a calculation resource cluster that is virtually created on a physical machine by container virtualization software and in which containers virtually created on the physical machine by the container virtualization software are clustered and arranged;
a cluster management unit that is virtually created on the physical machine by the container virtualization software and configured to manage control related to arrangement and operation of the containers clustered;
a plurality of data bases (DBs) that is connected outside the calculation resource cluster via a network and configured to store data related to the containers;
an external end point setting unit that is associated with the plurality of containers of the calculation resource cluster and associated with the plurality of DBs and in which a distribution ratio of traffic when data from the containers is distributed and transmitted to the plurality of DBs is set;
an abnormality detection unit that is created at an outside of the calculation resource cluster and the cluster management unit that are virtually created and configured to detect an abnormality in the DBs; and
an abnormality recovery handling unit that is created at the outside and configured to transmit, to the cluster management unit, a change command for setting the distribution ratio to an abnormal DB detected by the abnormality detection unit to 0%, wherein
when the abnormality in the DBs is detected by the abnormality detection unit, the abnormality recovery handling unit is configured to acquire information of the external end point setting unit having an Internet Protocol (IP) address of the abnormality DB detected, from the cluster management unit, and transmit a command for setting the distribution ratio set in the external end point setting unit of the information acquired to 0% to the cluster management unit, and
the cluster management unit is configured to change the distribution ratio of the traffic to the abnormal DB to 0% in response to the command.

4. A virtualization system failure separation method by a virtualization system failure separation device, comprising:
clustering and arranging, on a calculation resource cluster virtually created on a physical machine by container virtualization software, containers virtually created on the physical machine by the container virtualization software;
virtually creating on the physical machine by the container virtualization software a cluster management unit that manages control related to arrangement and operation of the containers clustered;
arranging an end point setting unit that is associated with a plurality of containers and serves as an end point of communication data in which a distribution ratio of traffic to each container is set, in association with the containers;
detecting an abnormality in the containers, at an outside of the calculation resource cluster and the cluster management unit that are virtually created;
transmitting, to the cluster management unit, a change command created at the outside and for setting the distribution ratio to an abnormal container detected by the step of detecting an abnormality in the containers to 0%; and
setting, using the cluster management unit, the distribution ratio of the end point setting unit associated with the abnormal container to 0% in response to the change command.

5. The virtualization system failure separation method according to claim 4, further comprising:
transmitting a recovery command for gradually increasing traffic to a container to be recovered to a predetermined traffic value to the cluster management unit at a time of recovery of the abnormal container, and
gradually increasing the distribution ratio of the end point setting unit associated with the container to be recovered to the predetermined traffic value in response to the recovery command.

6. (canceled)
